(19) United States
(12) Patent Application Publication
(10) Pub. No.: US 2009/0119224 A1
(43) Pub. Date: May 7, 2009

(54) Algorithmic trading system, a method for computer-based algorithm trading and a computer program product

(75) Inventor: Donato Petrino, Hessen (DE)

Correspondence Address: Cynthia Smith, 311 South Wacker Dr.; Ste. #980, Chicago, IL, 60606, US

(73) Assignee: RTS Realtime Systems Software GmbH, Frankfurt/Main (DE)

(21) Appl. No.: 11/666,108

(22) PCT Filed: Nov. 18, 2005
(86) PCT No.: PCT/EP05/12384

§ 371 Date: Apr. 24, 2007

(51) Int. Cl. G06N 5/02; G06Q 40/00; G06F 15/16

(52) U.S. Cl. 705/36 R; 705/37; 709/204; 706/47

(57) ABSTRACT

An algorithmic trading system, comprising
a rule memory for storing at least one rule for algorithmic trading, wherein the at least one rule includes
   at least one logic operation and/or arithmetic operation which uses pre-input data, and
   at least one order/quote agent logic for an order transaction management and/or quote transaction management,
a parameter value memory for storing at least one parameter value that represents an strategy instance for a rule,
a strategy generation unit that is configured to generate at least one trading strategy using at least one stored rule and at least some of the stored parameter values, such that the generated at least one trading strategy comprises at least one order/quote agent for handling the order transaction management and/or the quote transaction management according to the at least one logic operation and/or arithmetic operation,
a processing unit for processing the at least one generated trading strategy by executing the at least one order/quote agent within the trading strategy.

### CROSS-REFERENCE TO RELATED APPLICATIONS

### BACKGROUND OF THE INVENTION

The invention refers to an algorithmic trading system, a method for computer-based algorithmic trading and a computer program product.

An increasing number of markets have been converted from a manual system of trading, in which traders operate from a market trading floor, to an electronic system of trading, in which traders operate from remotely connected computers. Such an electronic market operates trading host computers, which actually perform the trading function. The traders interact with the hosts by means of client terminals, connected to the host by a local and/or wide area network. The client terminal executes computer programs that generate a display that allows a trader to be appraised of the status of the market and to perform trading activities.

However, in case that a large amount of financial instruments (e.g. stocks, futures, options, commodities, bonds, etc.) are to be traded or in case that financial instruments are to be traded in a very short time, it became apparent that a manual trading tends to become too slow and too susceptible to errors.

Therefore, so called algorithmic trading systems have been proposed, in which an automatic algorithmic trading is performed according to developed algorithms. The algorithms can be developed by a user. Furthermore, a concrete trading strategy is instantiated using a developed algorithm and using predefined parameters, wherein the algorithm is clearly instantiated using the parameters, for example an information about the financial instrument that should be traded or about a price for a financial instrument at which an ask order or a bid order should be automatically generated and/or a quantity which denotes an amount of units that should be automatically bid or asked for.

It became apparent that the development of algorithms and strategies using standard programming languages such as C or C++ is very time consuming and expensive. It may take a huge amount of manpower (e.g. a plurality man-months) to implement even a rather simple trading algorithm and strategy.

It is an object of the invention to provide an algorithmic trading system and a method for computer-based algorithmic trading which enable an easier development of algorithms and strategies.

The object is achieved by an algorithmic trading system, a method for computer-based algorithmic trading and a computer program product comprising the features according to the independent patent claims. Exemplary embodiments of the invention emerge from the dependent claims. The described embodiments are valid for the algorithmic trading system as well as for the method for computer-based algorithmic trading and the computer program product.

### SUMMARY OF THE INVENTION

An algorithmic trading system comprises a rule memory for storing at least one rule for algorithmic trading, wherein the at least one rule includes at least one logic operation and/or arithmetic operation which uses pre-input data, and at least one order/quote agent logic for an order transaction management and/or quote transaction management. Furthermore, a parameter value memory for storing at least one parameter value that represents an strategy instance for a rule is provided. Moreover, the algorithmic trading system comprises a strategy generation unit that is configured to generate at least one trading strategy using at least one stored rule and at least some of the stored parameter values such that the generated at least one trading strategy comprises at least one order/quote order and/or quote agent. For handling the order transaction management and/or the quote transaction management according to the at least one logic operation and/or arithmetic operation, and a processing unit for processing the at least one generated trading strategy by executing the at least one order/quote agent within the trading strategy.

A computer-implemented method for algorithmic trading, comprises storing at least one rule for algorithmic trading in a rule memory, wherein the at least one rule includes at least one logic operation and/or arithmetic operation which uses pre-input data, and at least one order/quote agent logic for an order transaction management and/or quote transaction management. Furthermore, at least one parameter value is stored that represents an application instance for a rule in a parameter value memory and at least one trading strategy is generated using at least one stored rule and at least some of the stored parameter values, such that the generated at least one trading strategy comprises at least one order/quote agent for handling the order transaction management and/or the quote transaction management according to the at least one logic operation and/or arithmetic operation. The at least one generated trading strategy is processed by executing the at least one order/quote agent within the trading strategy.

According to another aspect of the invention, a computer program product is provided that comprises the above-mentioned steps when it is executed by a processor.

An algorithmic trading system may generally be understood as an electronic trading system, in which the trading orders are generated and executed at least partly by a computer, e.g. by means of a computer program or a corresponding hardware. Generally, the trading orders are generated according to predetermined trading rules, also called trading algorithms.

Clearly, one aspect of the invention can be seen in the very easy and convenient definition of the one or more rules for algorithmic trading, wherein the one or more rules include one or more logic operations and/or one or more arithmetic operations which use pre-input data, and at least one order/quote agent logic for an order transaction management and/or quote transaction management. The rules are developed in a predefined high-level structural programming language, thereby enabling even a person who is not very skilled in computer programming to formulate even complex rules for algorithmic trading. For a concrete instantiation of the rule and therewith for a concrete trading strategy, a trader can simply select a developed general rule and define parameter values. The selected rule and the parameter values are used for the generation of a new instance of the rule, in the following also called trading strategy. The trading strategy already includes the at least one order/quote agent that can, if started, independently perform trading activities, wherein behaviour of the at least one order/quote agent can as well be developed in high-level programming language.

According to an embodiment of the invention, the algorithmic trading system further comprises a market data memory for storing market data, wherein the rule includes at least one logic operation and/or arithmetic operation which uses the market data.

This embodiments provides the advantage that one of the most important type of information for algorithmic trading, the actual market data, can be taken into account.

Alternatively or in addition to the market data, any other information which may be relevant for the financial instruments may be taken into account (and in this case may be stored), e.g. electronic news data or position data which may be provided by a news or press agency.

The quote transaction management may comprise at least one of the following transactions: add quote, delete quote, change quote. In other words, in the context of the quote transaction management add quote messages may be generated and transmitted to an electronic exchange, with which it is requested at the electronic exchange to add a quote to its order book. Further, delete quote messages may be generated and transmitted to an electronic exchange, with which it is requested at the electronic exchange to delete a quote from its order book. Eventually, change quote messages may be generated and transmitted to an electronic exchange, with which it is requested at the electronic exchange to change quote is changed in its order book.

In a corresponding manner, the order transaction management may comprise at least one of the following transactions: add order, delete order, change order. In other words, in the context of the order transaction management, add order messages may be generated and transmitted to an electronic exchange, with which it is requested at the electronic exchange to add an order to its order book. Further, delete order messages may be generated and transmitted to an electronic exchange, with which it is requested at the electronic exchange to delete an order from its order book. Eventually change order messages may be generated and transmitted to an electronic exchange, with which it is requested at the electronic exchange to change an order in its order book.

The order may be an ask order or a bid order. The bid order represents the order for buying an arbitrary number of units of the respective financial instrument. The ask order represents the order for selling an arbitrary number of units of the respective financial instrument.

The order/quote agent may be configured to generate an order and/or a quote.

Furthermore, a receiving/transmitting unit for receiving and/or transmitting messages from or to a connected electronic exchange may be provided in the algorithmic trading system.

According to another exemplary embodiment of the invention, the at least one rule includes a stop condition, and the processing unit is configured to stop the execution of the at least one generated trading strategy if the stop condition is met.

This embodiment enables a developer of a rule to provide an explicit stop condition in order to guarantee that the automatically executed trading strategy does not behave meaningless or even dangerous for the respective trader.

The processing unit may be configured to start and/or stop the execution of the at least one generated trading strategy in response to a start message or stop message received from a trader client computer.

This embodiment enables a trader to explicitly start and stop the instantiated rule, i.e. the trading strategy, at any time which is convenient for him. This even further enhances the ease of use for the trader, which becomes more and more important with an increasing number of running trading strategies one trader is responsible for.

According to another aspect of the invention, the algorithmic trading system is configured to trade at least one of the following types of financial instruments:

stocks, and/or

futures, and/or

options, and/or

commodities, and/or

bonds.

In general, any kind of financial instrument may be subject of being traded with the algorithmic trading system.

Exemplary embodiments of the invention are shown in the figures and will be described in more detail below.

### BRIEF DESCRIPTION OF THE DRAWINGS

FIG. 1 shows an algorithmic trading system according to an exemplary embodiment of the invention;

FIG. 2 shows the algorithmic trading server computer of FIG. 1 in more detail;

FIG. 3 shows a flow diagram illustrating the development of a rule in accordance with an exemplary embodiment of the invention;

FIGS. 4A and 4B show a flow diagram illustrating of inputting parameter values of a selected rule and the instantiation of the selected rule using the parameter values in accordance with an exemplary embodiment of the invention;

FIG. 5 shows a flow diagram illustrating the instantiation step of FIG. 4B in more detail; and

FIG. 6 shows a flow diagram illustrating the execution of an instantiated trading strategy in accordance with an exemplary embodiment of the invention.

### DETAILED DESCRIPTION OF THE PREFERRED EMBODIMENTS

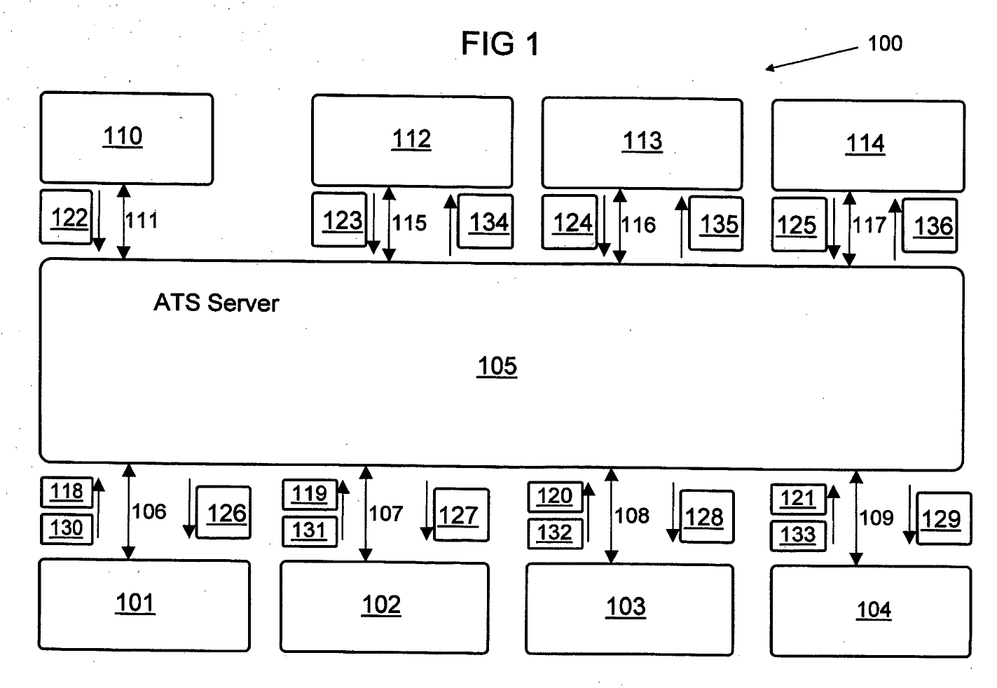

FIG. 1 shows an exemplary embodiment of an algorithmic trading system 100. The algorithmic trading system 100 comprises a plurality of financial instrument servers, e.g. a plurality of stock exchange servers. According to this embodiment, the algorithmic trading system 100 comprises a first server computer 101 from the XETRA exchange infrastructure, a second server computer 102 from the Eurex exchange infrastructure, a third server computer 103 from the Euronext exchange infrastructure, a fourth server computer 104 from the LSE exchange infrastructure, and so on. In general, an arbitrary number of exchange infrastructures can be included in the algorithmic trading system 100.

Furthermore, the algorithmic trading system 100 comprises an algorithmic trading server computer 105, which will be described in detail below.

The server computers 101, 102, 103, 104 from the respective exchange infrastructures are coupled to the algorithmic trading server computer 105 by means of communication connections 106, 107, 108, 109. The communication connections 106, 107, 108, 109 can be provided by a Wide Area Network (WAN), by means of a mobile radio communication network and/or a fixed communication network. By means of example, an Internet based communication connection can be used for communication between a respective server 101, 102, 103, 104 to the algorithmic trading server computer 105.

Moreover, at least one rule development client computer 110 is provided, generally speaking, an arbitrary number of rule development client computers 110. The rule development client computer 110 is adapted to create and edit trading rules by a user rule developer and is connected to the algorithmic trading server computer 105 by means of a further communication connection 111, according to; in this embodiment, by means of a local area network (LAN) connection, in an alternative embodiment, by means of a any communication connection as described above.

An arbitrary number of trading client computers 112, 113, 114 is provided for monitoring and creating strategies based on the developed rules for trading the financial instruments via the algorithmic trading server computer 105 at one or all of the server computer 101, 102, 103, 104. Each of the trading client computers 112, 113, 114 is connected to the algorithmic trading server computer 105 via communication connections 115, 116, 117 which can be embodied as described above.

Each electronic exchange (e.g. XETRA, Eurex, Euronext, LSE) provides an exchange order book which includes each of the bid orders and ask orders for each of the financial instruments traded by the respective stock exchange. Each of the server computers 101, 102, 103, 104 provides market data in market data messages 118, 119, 120, 121 to the algorithmic trading server computer 105.

The market data may include at least one of the following types of data:
Bid order data, which describe each bid order (e.g. price and quantity of the traded financial instrument) for each of the traded financial instrument, and/or
Accumulated bid order data, which describe accumulated bid orders (e.g. price and accumulated quantity of the traded financial instrument) for each of the traded financial instrument, and/or
Ask order data, which describe each ask order (e.g. price and quantity of the traded financial instrument) for each of the traded financial instrument, and/or
Accumulated ask order data, which describe accumulated bid orders (e.g. price and accumulated quantity of the traded financial instrument) for each of the traded financial instrument, and/or
Last traded price data that represents the most recent traded price for each of the traded financial instrument, and/or
Last traded quantity data that represents the most recent traded quantity for each of the traded financial instrument, and/or
Total turnover data that represents the total traded quantity for each of the traded financial instrument.

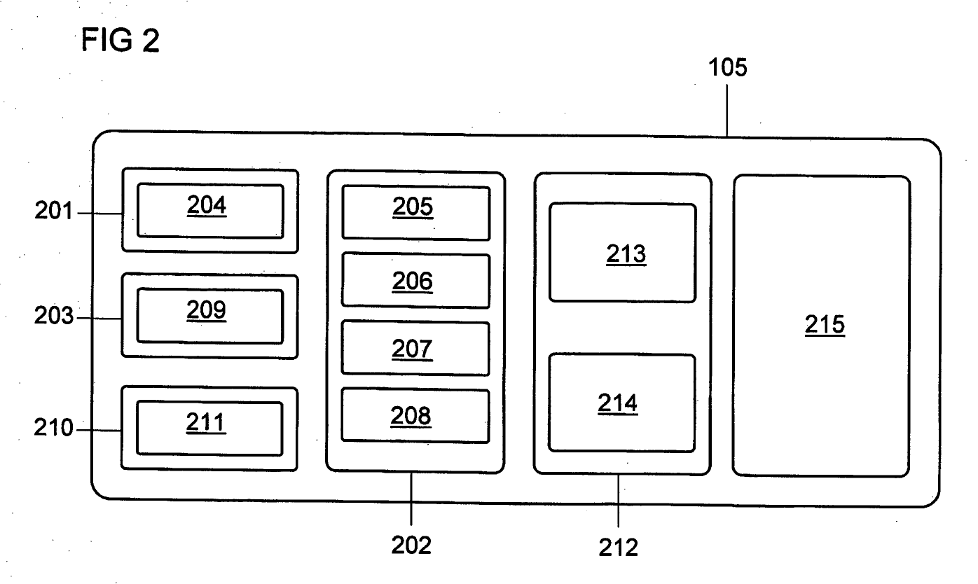

The market data messages 118, 119, 120, 121 are received and stored by the algorithmic trading server computer 105 in a market data memory 201 (see FIG. 2).

Moreover, in case a server computer 101, 102, 103, 104 executes a received order, it generates an execution notification message and transmits a respective execution notification message 130, 131, 132, 133.

A rule developer usually inputs (creates and/or edits) trading rules by means of a rule editor provided by the rule development client computer 110. The created or edited trading rules (at least one trading rule) are transmitted from the rule development client computer 110 to the algorithmic trading server computer 105 in a rule message 122.

The algorithmic trading server computer 105 receives the rule message 122 and stores the created or edited rule in a rule memory 202, also called rule library.

Furthermore, a trader, who uses one trading client computer of the trading client computers 112, 113, 114, inputs parameter values so as to instantiate a rule stored and offered by the algorithmic trading server computer 105, thereby creating a strategy. Further, the trading client computer 112, 113, 114 is configured to provide means for amending the parameter values of a strategy and for providing information about the results of the trading strategy via a graphical user interface so that the trader can monitor the effects and the state of the strategy run by the algorithmic trading server computer 105, as will be described in detail below.

The parameter values which are input by the trader are transmitted from the respective trading client computer 112, 113, 114 to the algorithmic trading server computer 105 via the communication connections 115, 116, 117 in a respective parameter value message 123, 124, 125.

The parameter values which are received by the algorithmic trading server computer 105 are stored in a parameter value memory 203 of the algorithmic trading server computer 105. (Note: combined this [0047] with [0046] such that subsequent paragraphs decreased by one number)

As mentioned above and as will be described in more detail below, the algorithmic trading server computer 105 generates bid orders and ask orders in accordance with the trading strategies and thus also in accordance with the respective rule using the stored market data and transmits them in a order message 126, 127, 128, 129 to the respective server computer 101, 102, 103, 104.

Furthermore, the algorithmic trading server computer 105 generates market monitoring data and transmits them to the respective trading client computer 112, 113, 114 in a market monitoring data message 134, 135, 136 so that the trader can monitor the development of the trading of interest and thus the effects of his strategy or strategies. If necessary, the trader can amend the strategy or strategies in response to the monitored data.

It should be mentioned that the functionality of the rule development client computer 110 and one or more of the trading client computers 112, 113, 114 can be implemented together in one client computer so that a user can freely select the role he wishes to take over within the algorithmic trading system, in other words, so that the user can freely select as to whether he wants to create/edit rules or whether he wants to create/edit parameters of rules and monitor one or more strategies so as to act as a trader.

FIG. 2 shows the algorithmic trading server computer 105 in more detail.

As already mentioned above, the algorithmic trading server computer 105 comprises
a market data memory 201 for storing received market data 204;
a rule memory 202 for storing received rules 205, 206, 207, 208;
a parameter value memory 203 for storing received parameter values 209;
a strategy memory 210 for storing strategies 211 which are instantiated using the rules 205, 206, 207, 208 and the parameter values 209.

The algorithmic trading server computer 105 further comprises a processing unit 212, comprising a compiler unit 213 and an interpreter unit 214. The functionality of the compiler unit 213 and the interpreter unit 214 will be described in more detail below. The processing unit 212 is configured to execute the trading strategies and provides the communication mechanisms for the bidirectional communication of the algorithmic trading server computer 105 with the rule development client computer 110, with the trading client computers 112, 113, 114 as well as with the electronic exchanges. Further, a receiving/transmission unit 215 is provided for receiving and transmitting messages from/to the rule development client computer 110, the trading client computers 112, 113, 114 and the electronic exchanges, in other words the server computers 101, 102, 103, 104. It should be noted that the receiving/transmission unit 215 is inter alia configured to communicate with the electronic exchanges according to the respectively required communication protocol.

In this context it should be mentioned that the respective data, e.g. the market data are updated very frequently (e.g. in response to the receipt of a new market data message) in the respective memory.

The rules are formulated by the rule developer in a rule definition language, clearly in form of a template.

As an example of a trading rule, the following trading idea is desired to be implemented.

It is assumed that for a traded financial instrument, the electronic exchange provides a so called market depth, that is a bid list of respectively currently pending bid prices with corresponding bid quantities and a ask list of respectively currently pending ask prices with corresponding ask quantities.

Such a market depth might be visualized for a financial instrument A as follows:

Financial instrument A:

| Bid | | | | |
|---|---|---|---|---|
| Quantity | Bid | Level | Ask | Ask Quantity |
| 1000 | 100.00 | 1 | 101.00 | 500 |
| 1200 | 99.50 | 2 | 101.20 | 400 |
| 1300 | 99.15 | 3 | 102.50 | 850 |
| 430 | 98.75 | 4 | 103.75 | 1150 |

As an example, the above market depth means that at Level 1, there exists at least one bid order for buying 1000 units of financial instrument A at a price of 100.00. Furthermore, there exists at least one ask order for selling 500 units of financial instrument A at a price of 101.00, and so on.

As a trading idea, it is assumed that a bid order should be generated for buying financial instrument A each time when the ask price at level 1 is less or equal to a first predefined value and that an ask order should be generated for selling financial instrument A each time when the bid price is greater or equal to a second predefined value.

In accordance to this trading idea, the rule developer formulates a trading rule in a predefined syntax and inputs the trading rule into the rule development client computer 110. The predefined syntax is a high-level language syntax providing the possibility to define parameters, variables and order/quote agents using the rule editor of the rule development client computer 110.

The parameters may be fixed parameters, i.e. parameters that cannot be changed during run-time of the instantiated strategy or changeable parameters, i.e. parameters that can be changed during run-time of the instantiated strategy. The parameters should be of a predefined type, e.g. of a Boolean type, of a number type, of a string type, of a time point type, of a time duration type, or of another predefined type.

Variables are to be understood in the context of this description to represent a user-named logical placeholder for an expression of a given type, e.g. of a Boolean type, of a number type, of a string type, of a time point type, of a time duration type, or of another predefined type. The expression may in general have an arbitrary complexity.

An expression may comprise numerical operators (such as “+”, “−”, “*”, “/”, “modulo”), and/or logical operators (such as “AND”, “OR”, “NOT”). Furthermore, control structures may be included in the expression, e.g. “IF . . . THEN . . . ELSE”, “WHILE . . . DO”, “FOR . . . DO”. In addition, an expression may comprise built-in functions, in other words predefined functions which are stored in a function library and can be called during run-time. The above described elements may be concatenated with one another using the above-described operators so as to result in the desired numerical or Boolean operation.

An order/quote agent is to be understood in the context of this description to represent a user-named logic unit for handling the order transaction management and/or the quote transaction management. The order transaction management may comprise the adding (entering), the deletion and the change of at least one order at a time, e.g. the adding (entering), the deletion and the change of exactly one order at a time. The quote transaction management may comprise the adding (entering), the deletion and the change of at least one quote at a time, e.g. the adding (entering), the deletion and the change of exactly one quote at a time. A quote is to be understood a tuple of a bid order and an ask order or a single-sided quote comprising only a bid order or an ask order.

In the following, the syntax of the rule that represents the above-described trading idea according to a first embodiment of the invention will be described in more detail:

Rule: “ElectronicEye”
Fixed Parameters:

| | |
|---|---|
| INSTR | TRADABLE |
| ACC | STRING |

Changeable Parameters:

| | |
|---|---|
| BUY_LIMIT | NUMBER |
| SELL_LIMIT | NUMBER |
| MAX_POS | NUMBER |

Variables:

| | |
|---|---|
| CURR_POS := | pLong(INSTR, ACC) − pShort(INSTR, ACC) |
| BUY_OPP := | BUY_LIMIT >= mAskPrice(INSTR, 1) |
| SELL_OPP := | SELL_LIMIT <= mBidPrice(INSTR, 1) |

Order Agent: “Buyer”

| | |
|---|---|
| trd := | INSTR |
| acc := | ACC |
| buy := | true |
| qty := | min(mAskQty(INSTR, 1), |
| | MAX_POS − CURR_POS) |
| lmt := | mAskPrice(INSTR, 1) |
| cnd := | BUY_OPP |

Order Agent: “Seller”

| | |
|---|---|
| trd := | INSTR |
| acc := | ACC |
| buy := | false |
| qty := | min(mBidQty(INSTR, 1), |
| | MAX_POS + CURR_POS) |
| lmt := | mBidPrice(INSTR, 1) |
| cnd := | SELL_OPP |
| Off condition := | abs(CURR_POS) > MAX_POS |

To begin with, the rule is denoted with a unique user-defined name, in this case “ElectronicEye”.

The left parameter column in each case denotes the name of the respective parameter and the right parameter column comprises the definition of the type of the assigned parameter.

In the example described above, the first fixed parameter INSTR (which denotes the financial instrument the Rule refers to) is of the parameter type TRADABLE (which denotes a tradable financial instrument).

Moreover, the second fixed parameter ACC (which denotes the trading account) is of the parameter type STRING.

The first changeable parameter BUY_LIMIT (which denotes the maximum limit of the ask order price at which the financial instrument would be bought according to the rule; if the ask order price is less or equal to the BUY_LIMIT, a buy order would be triggered; in other words, the BUY_LIMIT represents the maximum price the trader is willing to pay for the financial instrument) is of the parameter type NUMBER.

The second changeable parameter SELL_LIMIT (which denotes the minimum limit of the bid order price at which the financial instrument would be sold according to the rule; if the bid order price is greater or equal to the SELL_LIMIT, a sell order would be triggered; in other words, the SELL_LIMIT represents the minimum price the trader is willing to sell the financial instrument for) is of the parameter type NUMBER.

The third changeable parameter MAX_POS defines the position limit range, i.e. the maximum amount of the financial instrument the trader may be long or short.

The left variable column in each case denotes the name of the respective variable and the right variable column comprises the expression that is used for determining the value of the assigned variable.

In the example described above, the first variable CURR_POS is defined as the current position with respect to the financial instrument. The current position is determined by the difference between the bought amount of the financial instrument (pLong(INSTR, ACC)) and the sold amount of the financial instruments (pShort(INSTR, ACC)). The CURR_POS is a variable that evaluates to a NUMBER and therefore the value of the first variable is a NUMBER expression.

The second variable BUY_OPP is defined as a comparison of the first changeable parameter BUY_LIMIT with the built-in function mAskPrice(INSTR, 1), which represents the ask order price of the financial instrument at the level 1 of market depth. The second variable BUY_OPP evaluates to a BOOLEAN value and is TRUE (in case that the value of the first changeable parameter BUY_LIMIT is greater than or equal to the ask order price of the financial instrument at the level 1 of market depth) or is FALSE (in any other case).

The third variable SELL_OPP is defined as a comparison of the second changeable parameter SELL_LIMIT with the built-in function mBidPrice(INSTR, 1), which represents the bid order price of the financial instrument at the level 1 of market depth. The third variable SELL_OPP evaluates to a BOOLEAN value and is TRUE (in case that the value of the first changeable parameter SELL_LIMIT is less than or equal to the bid order price of the financial instrument at the level 1 of market depth) or is FALSE (in any other case).

In this context, it should be noted that pLong(x, y), pShort(x, y), mAskPrice(x, y) and mBidPrice(x, y) are examples of built-in functions, i.e. they are standard functions that are usually used by the rule language to build up the trading logic in the algorithmic trading system. Other examples for implemented built-in functions are:

mLastPrice(x):
this number function returns the price of the last trade of the financial instrument x;

mLastQty(x):
this number function returns the quantity of the last trade of the financial instrument x;

oExists(x):
this Boolean function returns TRUE if the order agent with the name x has an order and returns FALSE otherwise;

pLongAvg(x, y):
this number function returns the average price of the bought financial instrument x with respect to account y;

pShortAvg(x, y):
this number function returns the average price of the sold financial instrument x with respect to account y;

mBidQty(x, y):
this number function returns the bid order quantity of the financial instrument x at the level y of the market depth;

mAskQty(x, y):
this number function returns the ask order quantity of the financial instrument x at the level y of the market depth.

A first order agent with the name “Buyer” is defined by means of a plurality of buyer order agent variables, namely:
a first buyer order agent variable “trd” (of type TRADABLE), wherein the first fixed parameter INSTR is assigned to the first buyer order agent variable;
a second buyer order agent variable “acc” (of type STRING), wherein the second fixed parameter ACC is assigned to the second buyer order agent variable;
a third buyer order agent variable “buy” (of type BOOLEAN), wherein the third buyer order agent variable is TRUE in order to denote that the first order agent should have the function to constantly buy if the condition given below is met;
a fourth buyer order agent variable “qty” (of type NUMBER), wherein the fourth buyer order agent variable denotes the quantity that should respectively be bought by the first order agent if a bid order is generated; in this embodiment, the fourth buyer order agent variable is determined by the minimum of either the quantity of the ask order of level 1 (mAskQty(INSTR, 1)) or the difference between the parameter MAX_POS and the first variable CURR_POS;
a fifth buyer order agent variable “Imt” (of type NUMBER), wherein the fifth buyer order agent variable denotes the price limit at which the first order agent should generate bid orders for buying the financial instrument; in this embodiment, the fifth buyer order agent variable is determined using the built-in function mAskPrice(INSTR, 1);
a sixth buyer order agent variable “cnd” (of type BOOLEAN), wherein the sixth buyer order agent variable denotes the condition under which the first order agent should generate bid orders for buying the financial instrument; in this embodiment, the second variable BUY_OPP is assigned to the sixth buyer order agent variable.

Clearly, the first order agent generates a bid order in case that the second variable BUY_OPP is TRUE. In this case, a bid order is generated with the values according to the respective current values of above described order agent variables. As long as the value of the sixth buyer order agent variable “cnd”, the first order agent is responsible for generating the bid order and amending the generated bid order in response to the continuously monitored resulting value of the related variables, that are included in the first order agent. In other words, in case that a bid order has been generated with a first price limit at a first time instant and assuming that the market depth changes, e.g. mAskPrice(INSTR, 1) changes and therewith the value of the sixth buyer order agent variable changes to a second price limit at a second time instant, a bid order change message is generated by the first order agent and transmitted to the respective electronic exchange in order to change the bid order which is entered in the electronic exchange from the first price limit to the second price limit. Furthermore, in case that the sixth buyer order agent variable “cnd” becomes FALSE, the first order agent generates a corresponding bid order delete message and transmits it to the electronic exchange in order to delete the bid order which is entered in the electronic exchange.

As will be described later in detail, this is achieved by a continuous running of the instantiated rule (i.e. the corresponding strategy) and therewith by a continuous running of the order agents.

A second order agent with the name “Seller” is also defined by means of a plurality of seller order agent variables, namely:
a first seller order agent variable “trd” (of type TRADABLE), wherein the first fixed parameter INSTR is assigned to the first seller order agent variable;
a second seller order agent variable “acc” (of type STRING), wherein the second fixed parameter ACC is assigned to the second seller order agent variable;
a third seller order agent variable “buy” (of type BOOLEAN), wherein the third seller order agent variable is FALSE in order to denote that the second order agent should have the function to constantly sell if the condition given below is met;
a fourth seller order agent variable “qty” (of type NUMBER), wherein the fourth seller order agent variable denotes the quantity that should respectively be sold by the second order agent if an ask order is generated; in this embodiment, the fourth seller order agent variable is determined by the minimum of either the quantity of the bid order of level 1 (mBidQty(INSTR, 1)) or the sum of the parameter MAX_POS and the first variable CURR_POS;
a fifth seller order agent variable “Imt” (of type NUMBER), wherein the fifth seller order agent variable denotes the price limit at which the second order agent should generate ask orders for selling the financial instrument; in this embodiment, the fifth seller order agent variable is determined using the built-in function mBidPrice(INSTR, 1);
a sixth seller order agent variable “cnd” (of type BOOLEAN), wherein the sixth seller order agent variable denotes the condition under which the second order agent should generate ask orders for selling the financial instrument; in this embodiment, the third variable SELL_OPP is assigned to the sixth seller order agent variable.

The second order agent clearly generates ask orders in an analogous way as compared to the first order agent.

In an alternative embodiment of the invention, the functions of the first order agent and the second order agent can be combined into one common order agent having the function of both, either generating a bid order or an ask order. In this case, the respective expressions, generally the respective logic, would have to be adjusted accordingly.

In general, any kind of trading logic can be expressed in the above-described easy and comfortable manner even by a person who has no extraordinary skills in programming.

As a further optional feature, an off condition is provided in the rule that serves for predefining one or a plurality of Boolean expressions that in case either of them evaluates to TRUE, the operation of the rule is stopped or simply not started. In case the operation of the rule is stopped, all entered orders are automatically deleted, i.e. corresponding order delete messages are generated and transmitted to the electronic exchange. According to this embodiment of the invention, the off condition is a comparison of the absolute value of the first variable CURR_POS and the parameter MAX_POS.

In this context it should be mentioned that in an alternative embodiment of the invention, in addition to or as an alternative to the order agent(s), one or a plurality of quote agents may be provided that handles (generates, amends, deletes) quotes and corresponding messages for quote transaction management.

Another trading idea may be the so called tick trading, wherein the goal is to achieve gains through little moves back and forth between buying and selling the same financial instrument.

In the following, the syntax of the tick trading rule according to a second embodiment of the invention that represents the above-described trading idea will be described in more detail:

Rule: “TickTrading”
Fixed Parameters:

| | |
|---|---|
| INSTR | TRADABLE |
| ACC | STRING |

Changeable Parameters:

| | |
|---|---|
| PROFIT_TARGET | NUMBER |
| QTY | NUMBER |
| MAX_POS | NUMBER |

Variables:

| | |
|---|---|
| CURR_POS := | pLong(INSTR, ACC) − pShort(INSTR, ACC) |
| SHORT_OP_AVG := | eShortLastAvg(INSTR, ACC, |
| | abs(CURR_POS)) |
| LONG_OP_AVG := | eLongLastAvg(INSTR, ACC, |
| | abs(CURR_POS)) |

Order Agent: “Buyer”

| | |
|---|---|
| trd := | INSTR |
| acc := | ACC |
| buy := | true |
| qty := | min(QTY, MAX_POS − CURR_POS) |
| lmt := | mBidPrice(INSTR, 1) |
| cnd := | CURR_POS >= 0 |

Order Agent: “Seller”

| | |
|---|---|
| trd := | INSTR |
| acc := | ACC |
| buy := | false |
| qty := | min(QTY, MAX_POS + CURR_POS) |
| lmt := | mAskPrice(INSTR, 1) |
| cnd := | CURR_POS <= 0 |

Order Agent: “ProfitTaker”

| | |
|---|---|
| trd := | INSTR |
| acc := | ACC |
| buy := | CURR_POS < 0 |
| qty := | abs(CURR_POS) |
| lmt := | buy ? SHORT_OP_AVG − |
| | PROFIT_TARGET : |
| | LONG_OP_AVG + PROFIT_TARGET |
| cnd := | CURR_POS != 0 |
| Off condition := | abs(CURR_POS) > MAX_POS |

The left parameter column in each case denotes the name of the respective parameter and the right parameter column comprises the definition of the type of the assigned parameter.

In the example described above, the first fixed parameter INSTR (which denotes the financial instrument the Rule refers to) is of the parameter type TRADABLE (which denotes a tradable financial instrument).

Moreover, the second fixed parameter ACC (which denotes the trading account) is of the parameter type STRING.

A first changeable parameter PROFIT_TARGET is of the type NUMBER and denotes the amount to be gained within one buy and sell transaction.

A second changeable parameter QTY is of the type NUMBER and denotes the quantities with which the bid order or ask order is entered by the Buyer order agent or Seller order agent, respectively.

The third changeable parameter MAX_POS defines the position limit range, i.e. the maximum amount of the financial instrument the trader may be long or short.

The left variable column in each case denotes the name of the respective variable and the right variable column comprises the expression that is used for determining the value of the assigned variable.

In the example described above, the first variable CURR_POS is defined as the current position with respect to the financial instrument. The current position is determined by the difference between the bought amount of the financial instrument (pLong(INSTR, ACC)) and the sold amount of the financial instruments (pShort(INSTR, ACC)). The CURR_POS is a variable that evaluates to a NUMBER and therefore the value of the first variable is a NUMBER expression.

In the example described above, a second variable SHORT_OP_AVG is defined by the built-in function eShortLastAvg(INSTR, ACC, abs(CURR_POS)), which returns the average price of the current short position. The second variable SHORT_OP_AVG is a variable that evaluates to a NUMBER.

A third variable LONG_OP_AVG is defined by the built-in function eLongLastAvg(INSTR, ACC, abs(CURR_POS)), which returns the average price of the current long position. The third variable LONG_OP_AVG is a variable that evaluates to a NUMBER.

A first order agent “Buyer” according to the second embodiment is defined by means of a plurality of buyer order agent variables, namely:
a first buyer order agent variable “trd” (of type TRADABLE), wherein the first fixed parameter INSTR is assigned to the first buyer order agent variable;
a second buyer order agent variable “acc” (of type STRING), wherein the second fixed parameter ACC is assigned to the second buyer order agent variable;
a third buyer order agent variable “buy” (of type BOOLEAN), wherein the third buyer order agent variable is TRUE in order to denote that the first order agent should have the function to constantly buy if the condition given below is met;
the fourth buyer order agent variable “qty” denotes the quantity that should respectively be bought by the first order agent if a bid order is generated; in this embodiment, the fourth buyer order agent variable is determined by the minimum of either the fifth changeable parameter QTY or the first variable CURR_POS;
the fifth buyer order agent variable “Imt” is the result of the built-in function mBidPrice(INSTR, 1);
the sixth buyer order agent variable “cnd” evaluates TRUE if the first variable CURR_POS is greater than or equal to “0” and FALSE otherwise.

A second order agent with the name “Seller” is defined by means of a plurality of seller order agent variables, namely:
a first seller order agent variable “trd” (of type TRADABLE), wherein the first fixed parameter INSTR is assigned to the first seller order agent variable;
a second seller order agent variable “acc” (of type STRING), wherein the second fixed parameter ACC is assigned to the second seller order agent variable;
a third seller order agent variable “buy” (of type BOOLEAN), wherein the third seller order agent variable is FALSE in order to denote that the second order agent should have the function to constantly sell if the condition given below is met;
a fourth seller order agent variable “qty” (of type NUMBER) denotes the quantity that should respectively be sold by the second order agent if an ask order is generated; in this embodiment, the fourth order agent variable is determined by the minimum of either the fifth changeable parameter QTY or the sum of the first variable CURR_POS and the parameter MAX_POS;
the fifth seller order agent variable “Imt” (of type NUMBER) denotes the price limit at which the second order agent should generate ask orders for selling the financial instrument; in this embodiment, the fifth seller order agent variable is determined using the built-in function mAskPrice(INSTR, 1);
the sixth seller order agent variable “cnd” (of type BOOLEAN) denotes the condition under which the second order agent should generate ask orders for selling the financial instrument; in this embodiment, the sixth seller order agent variable evaluates to TRUE if the first variable CURR_POS is less than or equal to “0” and FALSE otherwise.

According to this embodiment of the invention, an additional third order agent “ProfitTaker” is provided which includes the following order agent variables:
a first profit taker order agent variable “trd” (of type TRADABLE), wherein the first fixed parameter INSTR is assigned to the first profit taker order agent variable;
a second profit taker order agent variable “acc” (of type STRING), wherein the second fixed parameter ACC is assigned to the second profit taker order agent variable;
a third profit taker order agent variable “buy” (of type BOOLEAN), wherein the third profit taker order agent variable is a comparison of the first variable CURR_POS with the value “0”; in this embodiment, the third profit taker order agent variable evaluates to TRUE if the first variable CURR_POS is less than “0” and FALSE otherwise;
a fourth profit taker order agent variable “qty” (of type NUMBER), wherein the fourth profit taker order agent variable denotes the quantity that should respectively be bought by the third order agent if the third profit taker order agent variable “buy” is TRUE, thereby generating a bid order, or that should respectively be sold by the third order agent if the third profit taker order agent variable “buy” is FALSE, thereby generating an ask order; in this embodiment, the fourth profit taker order agent variable is the absolute value of the first variable CURR_POS;
a fifth profit taker order agent variable “Imt” (of type NUMBER), wherein the fifth profit taker order agent variable denotes the price limit at which the third order agent should generate bid orders and ask orders for buying or selling the financial instrument depending on the third profit taker order agent variable “buy”; if the third profit taker order agent variable “buy” is TRUE, the third order agent should generate bid orders with a limit that results as the difference between the second variable SHORT_OP_AVG and the first changeable parameter PROFIT_TARGET; if the third profit taker order agent variable “buy” is FALSE, the third order agent should generate ask orders with a limit that results as the sum of the third variable LONG_OP_AVG and the first changeable parameter PROFIT_TARGET;
a sixth profit taker order agent variable “cnd” (of type BOOLEAN), wherein the sixth order agent variable denotes the condition under which the first order agent should generate bid orders for buying the financial instrument or the condition under which the first order agent should generate ask orders for selling the financial instrument; in this embodiment, the sixth profit taker order agent variable evaluates to TRUE if the first variable CURR_POS is not equal to “0”.

Clearly, according to this embodiment, it is assumed that if the first variable CURR_POS is initially “0”, the first order agent “Buyer” is generating a bid order with a limit that corresponds to the level 1 of the current market depth, resulting in joining the order book of the respective exchange in the level 1 position. Moreover, the second order agent “Seller” performs the analogous actions with regard to the ask order side. The third order agent “ProfitTaker” becomes active in case that either the bid order or the ask order is executed by the respective exchange. In this case, the third order agent “ProfitTaker” generates an order that is opposite to the order that previously has been executed with such a limit that the first changeable parameter PROFIT_TARGET is tried to be gained.

In alternative embodiments, any desired rule, e.g. the following rules may be implemented within the algorithmic trading server computer 105 (it should be noted that variations of the below described rules are also provided according to alternative embodiments of the invention):

Pairs trading rule:
A trading rule in which two financial instruments are traded such that they are related to one another, wherein a difference between two very similar financial instruments that are highly correlated is exploited.

Volume Weighted Average Price (VWAP):
VWAP is calculated by adding up the money traded for every transaction (price times shares traded) and then dividing by the total shares traded for the day; the theory is that if the price of a buy trade is lower than the VWAP, it is a good trade; the opposite is true if the price is higher than the VWAP.

Strategies taking into account so called Bollinger bands.

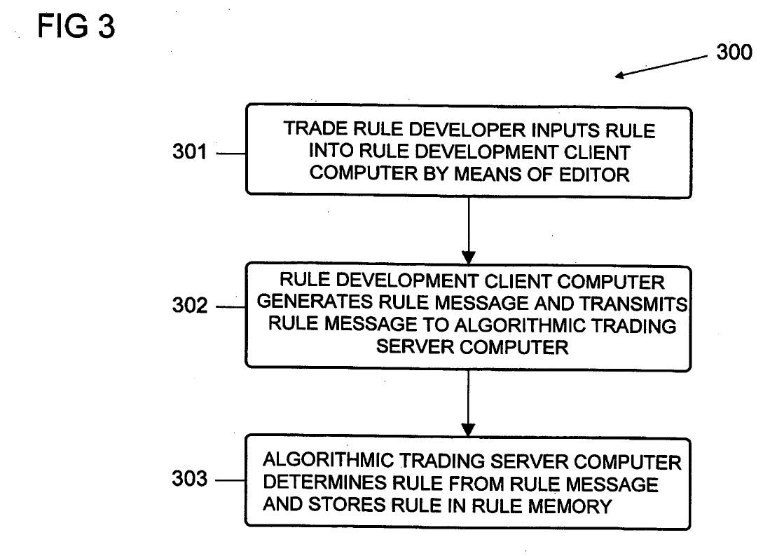

As described above, the trade rule developer inputs the above-described rule into the rule development client computer 110 my means of the editor (step 301 in flow diagram 300 of FIG. 3). The rule development client computer 110 generates a rule message which contains the developed rule in the above-described syntax and transmits the rule message to the algorithmic trading server computer 105 (step 302). After receipt of the rule message, the algorithmic trading server computer 105 determines the rule from the rule message and stores the rule in the rule memory 202 (step 303).

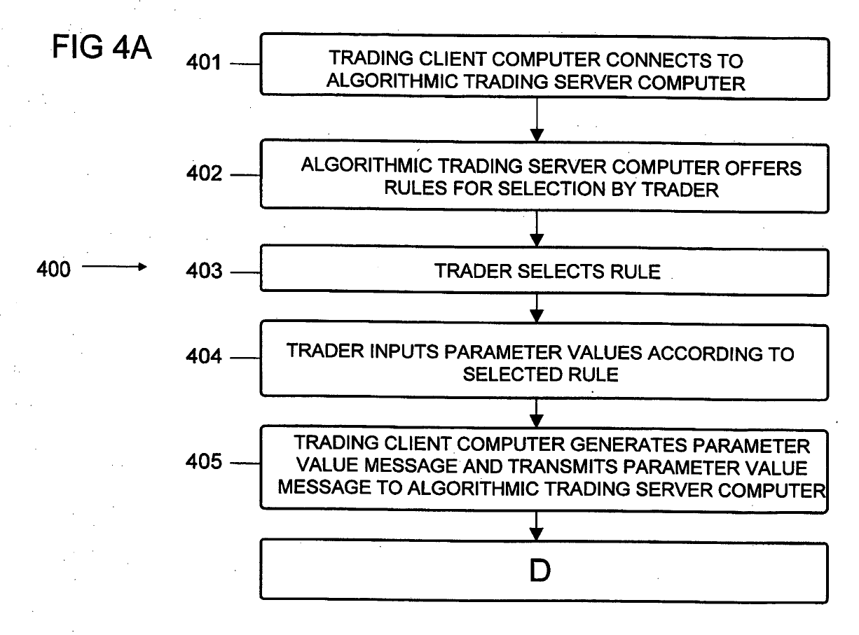

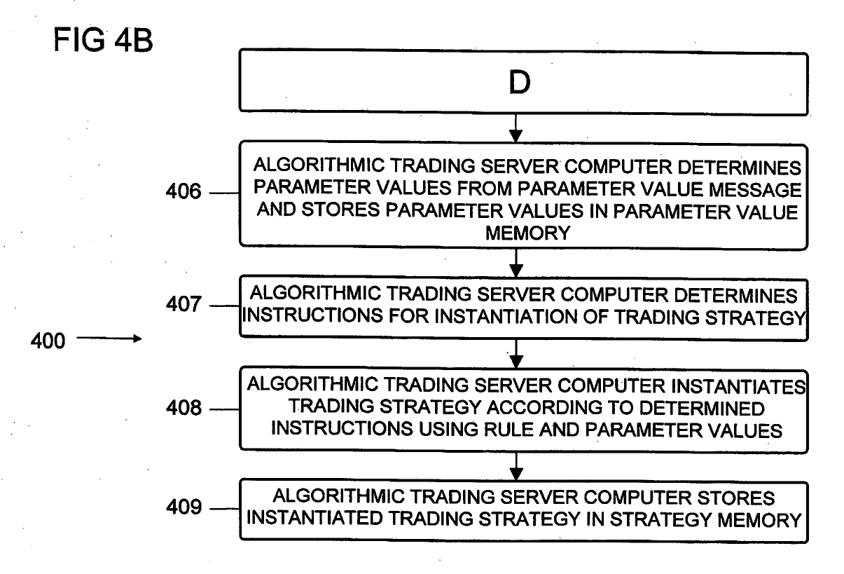

In case a trader wishes to instantiate a trading strategy that corresponds to a developed rule that is stored in the rule memory 202, the trader connects to the algorithmic trading server computer 105 via the Graphical User Interface (GUI) provided by the trading client computer 112, 113, 114 (step 401 in flow diagram 400 of FIGS. 4A and 4B).

The algorithmic trading server computer 105 offers the rules stored in the rule memory 202 for selection by the trader (step 402).

The trader selects the desired rule (step 403) and inputs parameter values that are necessary for instantiation of a strategy in accordance with the selected rule (step 404).

The trading client computer 112, 113, 114 generates a parameter value message which contains the parameter values which have been input by the trader and transmits the parameter value message to the algorithmic trading server computer 105 (step 405).

The parameter value message further includes instructions for instantiation of a trading strategy using the selected rule and the input parameter values. After receipt of the parameter value message, the algorithmic trading server computer 105 determines the parameter values from the parameter value message and stores the parameter values in the parameter value memory 209 (step 406).

Further, the algorithmic trading server computer 105 determines the instructions for instantiation of a trading strategy (step 407) and instantiates a trading strategy according to the determined instructions using the rule and the parameter values (step 408), thereby forming an internal code representation (pseudo code representation) of the instantiation of the trading strategy.

The instantiated trading strategy, i.e. the pseudo code representation, is stored in the strategy memory 210 (step 409).

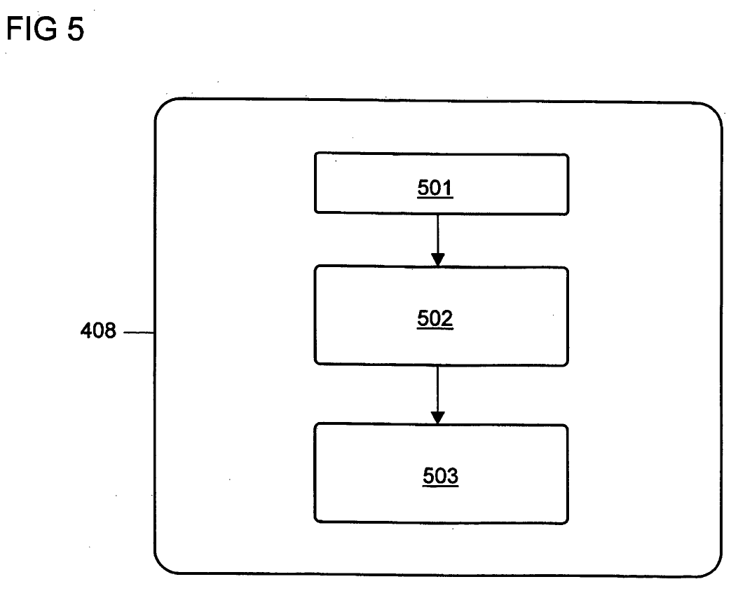

FIG. 5 shows the instantiation step 408 in more detail.

The uniquely named trading strategy comprising the combination of the selected rule with the corresponding parameter values (input values 501) is input to a compiler 502 that performs the following steps:
The compiler 502 performs a syntax validation and type checking on the named trading strategy;
The compiler 502 transforms the human readable representation of the named trading strategy as described above into an internal code representation (pseudo code representation) of the instantiation of the trading strategy 503. In this context, the expressions (i.e. the right side) of the human readable representation of the variables and off condition of the named trading strategy are transformed into a corresponding expression class within the pseudo code representation, e.g. a number expression class, a Boolean expression class, etc. These expression classes are abstract base classes. An object model is provided for the abstract base classes.

An interpreter interpretes the internal code representation 503 including the base classes representing function-like objects for determining the order/quote attributes.

The usage of the interpreter enables the trader to amend individual strategies during the execution of a large number of executed other strategies. An amended strategy might be re-compiled and the re-compiled amended strategy is then used as an input of the interpreter.

In an alternative embodiment, the human readable representation of the named trading strategies can directly be transformed into executable machine code.

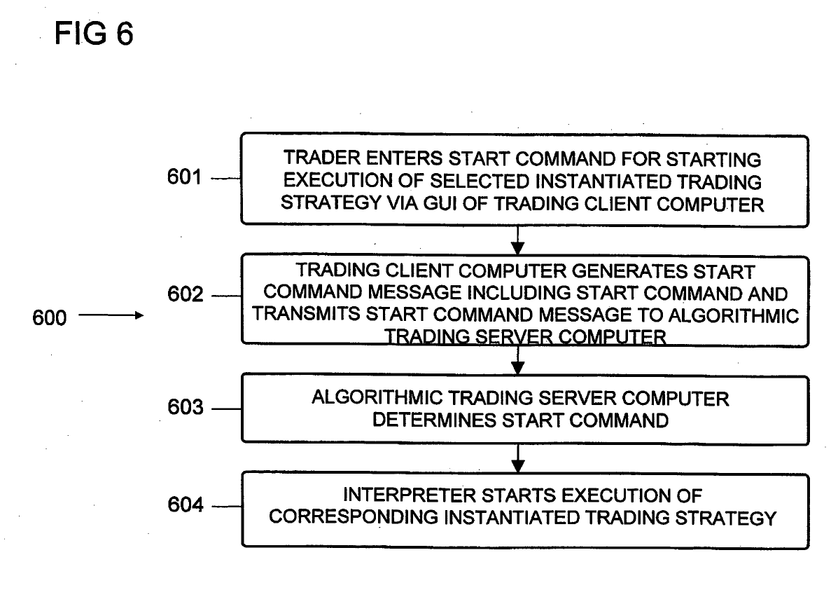

After having built the internal pseudo code representation of the instantiation of the trading strategy, it is assumed that the trader wants to execute an instantiated trading strategy. In order to do this, the trader inputs a start command for starting the execution of a selected instantiated trading strategy via the GUI that is presented to him by the trading client computer 112, 113, 114 (step 601 in flow diagram 600 in FIG. 6).

The trading client computer 112, 113, 114 then generates a start command message which includes the start command for the selected instantiated trading strategy and transmits the start command message to the algorithmic trading server computer 105 (step 602).

After receipt of the start command message, the algorithmic trading server computer 105 determines the start command (step 603) and the interpreter starts the execution of the corresponding instantiated trading strategy (step 604). Thus, the desired trading strategy is executed.

During the execution of the instantiated trading strategy, the respective order agent, which is executed within the instantiated trading strategy, determines the values of its local variables (i.e. the order agent variables) and, dependent from the values of the local variables, the order agent may, as described above:
generate an order add message for adding an order and transmit the order add message to the electronic exchange; upon receipt of the order add message, the electronic exchange enters the respective order into its order book;
generate an order change message for changing an order that has already been entered at the electronic exchange and transmit the order change message to the electronic exchange; upon receipt of the order change message, the electronic exchange changes the respective order in its order book according to the order change message;
generate an order delete message for deleting an order that has already been entered at the electronic exchange and transmit the order delete message to the electronic exchange; upon receipt of the order delete message, the electronic exchange deletes the respective order from its order book.

Furthermore, the algorithmic trading server computer 105 receives, as described above, updated market data by means of the market data messages 118, 119, 120, 121. If the market data in a received market data message 118, 119, 120, 121 leads to a change in the expressions and/or conditions within one or a plurality of the executed trading strategies, the interpreter determines the changes and re-evaluates the values of all related variables within all executed trading strategies. If a change is determined, the respective order agent performs the corresponding order transaction such that the order state at the electronic exchange is synchronized with the state represented by the local variables of the order agent.

It is claimed:

1. An algorithmic trading system, comprising:
a rule memory for storing at least one rule for algorithmic trading, wherein the at least one stored rule includes
at least one of a logic operation and an arithmetic operation which use pre-input data, and
at least one of an order agent and a quote agent, the order agent configured for order transaction management and the quote agent configured for quote transaction management;
a parameter value memory for storing at least one parameter value that represents a strategy instance of the at least one stored rule;
a strategy generation unit configured to generate at least one trading strategy using the at least one stored rule and the at least one stored parameter value, the at least one generated trading strategy comprising the at least one of the order agent and the quote agent for correspondingly handling order transaction management and quote transaction management in accordance with the at least one of the logic operation and the arithmetic operation; and
a processing unit for processing the at least one generated trading strategy by executing the at least one of the order agent and the quote agent within the at least one generated trading strategy.

2. The algorithmic trading system as claimed in claim 1, further comprising a market data memory for storing market data, wherein the at least one stored rule includes at least one of the logic operation and the arithmetic operation which use the market data.

3. The algorithmic trading system as claimed in claim 1, wherein the quote transaction management comprises at least one selected from the group consisting of a quote addition, a quote deletion and a quote change.

4. The algorithmic trading system as claimed in claim 1, wherein the order transaction management comprises at at least one selected from the group consisting of an order addition, an order deletion, and an order change.

5. The algorithmic trading system as claimed in claim 4, wherein the order addition comprises one of an ask order addition and a bid order addition, wherein the order deletion comprises one of an ask order deletion and a bid order deletion, and wherein the order change comprises one of an ask order change and a bid order change.

6. The algorithmic trading system as claimed in claim 1, wherein the order agent is configured to generate an order, and wherein the quote agent is configured to generate a quote.

7. The algorithmic trading system as claimed in claim 1, further comprising a receiving/transmitting unit for receiving and transmitting messages from and to a connected electronic exchange.

8. The algorithmic trading system as claimed in claim 1, wherein the at least one stored rule includes a stop condition, and wherein the processing unit is configured to stop the execution of the at least one generated trading strategy if the stop condition is met.

9. The algorithmic trading system as claimed in claim 1, wherein the processing unit is configured to start execution of the at least one generated trading strategy in response to a start message received from a trader client computer, and to stop execution of the at least one generated trading strategy in response to a stop message received from the trader client computer.

10. The algorithmic trading system as claimed in claim 1, wherein the algorithmic trading system is configured to trade at least one financial instrument selected from the group consisting of a stock, a future, an option, a commodity and a bond.

11. A computer-implemented method for algorithmic trading, comprising:
storing at least one rule for algorithmic trading in a rule memory, wherein the at least one stored rule includes
at least one of a logic operation and an arithmetic operation which use pre-input data, and
at least one of an order agent and a quote agent, the order agent configured for order transaction management and the quote agent configured for quote transaction management;
storing at least one parameter value in a parameter value memory, the at least one stored parameter value representing an application instance of the at least one stored rule;
generating at least one trading strategy using the at least one stored rule and the at least one stored parameter value, such that the at least one generated trading strategy comprises the at least one of the order agent and the quote agent for correspondingly handling order transaction management and quote transaction management in accordance with the at least one of the logic operation and the arithmetic operation; and
processing the at least one generated trading strategy by executing the at least one of the order agent and the quote agent within the at least one generated trading strategy.

12. A computer program product that comprises the following steps when it is executed by a processor:
storing at least one rule for algorithmic trading in a rule memory, wherein the at least one stored rule includes
at least one of a logic operation and an arithmetic operation which use pre-input data, and
at least one of an order agent and a quote agent, the order agent configured for order transaction management and the quote agent configured for quote transaction management;
storing at least one parameter value in a parameter value memory, the at least one stored parameter value representing an application instance of the at least one stored rule;
generating at least one trading strategy using the at least one stored rule and the at least one stored parameter value, such that the at least one generated trading strategy comprises the at least one of the order agent and the quote agent for correspondingly handling order transaction management and quote transaction management according to the at least one of the logic operation and the arithmetic operation; and
processing the at least one generated trading strategy by executing the at least one of the order agent and the quote agent within the at least one generated trading strategy.

13. The algorithmic trading system of claim 2, wherein the pre-input data includes the market data and other relevant financial instrument data.

14. The computer-implemented method of claim 11, wherein the pre-input data includes market data and other relevant financial instrument data.

15. The computer-implemented method of claim 11, wherein the quote transaction management comprises at least one selected from the group consisting of a quote addition, a quote deletion and a quote change.

16. The computer-implemented method of claim 11, wherein the order transaction management comprises at least one selected from the group consisting of an order addition, an order deletion and an order change.

17. The computer product of claim 12, wherein the pre-input data includes market data and other relevant financial instrument data.

18. The computer product of claim 12, wherein the quote transaction management comprises at least one selected from the group consisting of a quote addition, a quote deletion and a quote change.

19. The computer product of claim 12, wherein the order transaction management comprises at least one selected from the group consisting of an order addition, an order deletion and an order change.
